(19) United States
(12) Patent Application Publication
(10) Pub. No.: US 2025/0222809 A1
(43) Pub. Date: Jul. 10, 2025

(54) APPLIANCE FOR CHARGING BATTERIES OF ELECTRIC VEHICLES OR THE LIKE

(71) Applicant: META SYSTEM S.P.A., Reggio Emilia (RE) (IT)

(72) Inventor: Cesare LASAGNI, Reggio Emilia (RE) (IT)

(21) Appl. No.: 18/847,645

(22) PCT Filed: Mar. 14, 2023
(86) PCT No.: PCT/IB2023/052467

§ 371 Date: Sep. 16, 2024

(30) Foreign Application Priority Data
Mar. 17, 2022 (IT) 102022000005279

(51) Int. Cl. B60L 53/62; H02M 1/42

(52) U.S. Cl. CPC B60L 53/62; H02M 1/42

(57) ABSTRACT

The appliance (1) for charging batteries of electric vehicles or the like comprises: an input stage (S IN) comprising at least one input circuit (C1, C2, C3) and at least one switch (SW1, SW2, SW3) closable/openable; a power unit (POW); a command unit (COM) comprising at least one measuring device (PR); an interface unit (SYS) operatively connected to said switch (SW1, SW2, SW3) and being configured to send to the latter at least one closing/opening signal; wherein: the interface unit (SYS) comprises a detection device (PC) which is operatively connected upstream of said switch (SW1, SW2, SW3) and is configured to detect the presence of said electrical voltage and to generate at least one presence/absence signal, the interface unit (SYS) being configured to switch the presence/absence signal into the closing/opening signal; the measuring device (PR) is connected to the input circuit (C1, C2, C3) downstream of the latter.

### TECHNICAL FIELD

The present invention relates to an appliance for charging batteries of electric vehicles or the like.

### BACKGROUND ART

As is well known, electric vehicles exploit, for ground propulsion, the conversion of part of the chemical energy stored in one or more batteries (so-called “electric vehicle batteries”, EVBs) into electrical energy and the subsequent transfer of the latter to the motorized unit.

In order to enable periodic charging of the batteries, electric vehicles are provided with special appliances, already built into the vehicle, which are called on-board chargers, OBCs.

An example of such known appliances is schematically shown in FIG. 1.

With reference to this figure, it can be seen that known appliances are provided with an input stage S IN comprising one or more input circuits C1, C2, C3 (e.g., three) that can be connected to an external AC power supply line (e.g., of the single-phase, two-phase or three-phase type) and traversed by the input alternating current.

In more detail, a closable/openable switch SW1, SW2, SW3 (e.g., of the type of a relay) is arranged on each of the input circuits C1, C2, C3 to connect/disconnect the input circuits themselves to/from the power line.

In addition, one of the input circuits C1 comprises one or more auxiliary switches SW4, SW5 (e.g., in the case of three input circuits C1, C2, C3, two auxiliary switches) that connect it to the other input circuits C2, C3 and are responsible for switching from a three-phase/single-phase to a single-phase/three-phase configuration.

Next, the input stage S IN comprises input filters F_{IN1}, F_{IN2}, F_{IN3} which are arranged on each input circuit C1, C2, C3 downstream of the switches SW1, SW2, SW3 and of the auxiliary switches SW4, SW5 and are responsible for filtering disturbances from downstream to prevent them from reaching the power line.

In actual facts, once the switches SW1, SW2, SW3 and/or auxiliary switches SW4, SW5 have been traversed, the alternating current enters the input filters F_{IN1}, F_{IN2}, F_{IN3} and is then delivered at output from the latter to the next components of the appliance.

In this regard, the appliances of known type are also provided with a power unit POW operating at high voltages which is arranged downstream of the input stage S IN and is configured to receive at input the alternating current from the latter and to deliver at output a predefined direct current to be sent to the battery EVB.

To comply with this purpose, a special power circuitry is arranged within the power unit POW, which comprises, among other components, a power factor correction PFC device, intended to correct the current input waveform, and a DC/DC converter device.

In addition, an output filter Four configured to limit the disturbances generated by the conversion to the output is arranged downstream of the power unit POW. Once the output filter Four has been traversed the direct current can, therefore, be sent to the battery EVB.

It should be specified that in order to adequately perform its function, the power factor correction PFC device must be properly adjusted according to the instantaneous value and to the phase of the electrical voltage at input to the power unit POW.

In fact, this allows the power factor correction PFC device to be used profitably to correct both the phase shift and the shape of the current with respect to the relevant voltage, thus complying with international regulations.

Just in this sense, known appliances comprise a command unit COM operatively located between the input stage S IN and the power unit POW.

In this case, the command unit COM is provided with a resistive divider PR which is configured to measure the input electric voltage and its zero crossing; thus, once these measurements have been made, the command unit COM can adjust the power factor correction PFC device accordingly.

Finally, known appliances comprise an interface unit SYS which is connected to the control unit CNT of the electric vehicle and is configured to send information to the latter regarding, e.g., the value of the input voltage and current, the electrical conversion efficiency and more.

Unlike the power unit POW, the interface unit SYS operates at low voltages and is typically shielded; this prevents any electromagnetic disturbances generated by the high-voltage switching present in the power unit POW, propagating first to the command unit COM and then to the interface unit SYS, from being transmitted to the control unit CNT.

The interface unit SYS is, in addition, connected to the switches SW1, SW2, SW3 and is configured to control the opening and closing of the latter depending on whether there is electrical voltage at input or not, respectively.

Not only that, but the interface unit SYS is also connected to the auxiliary switches SW4, SW5 and is configured to control the opening and closing of the latter to switch from a three-phase to a single-phase configuration or vice versa.

To enable the interface unit SYS to do this, the resistive divider PR is, in the known appliances, connected to the input circuits C1, C2, C3 upstream of each of switches SW1, SW2, SW3 and of the auxiliary switches SW4, SW5.

In fact, the above connection mode allows the resistive divider PR to be used not only to make the aforementioned measurement, but also to adjust the closing/opening of the switches SW1, SW2, SW3 and of the auxiliary switches SW4, SW5 made by the interface unit SYS.

In the known appliances, therefore, the resistive divider PR is configured to detect the presence of electrical voltage at input and to generate, following the detection, a presence/absence signal to be sent to the interface unit SYS.

The interface unit SYS then switches such a presence/absence signal into a closing/opening signal with which to command or not the closure of one or more of the switches SW1, SW2, SW3 and/or of the auxiliary switches SW4, SW5 and to allow, in doing so, the alternating current to flow to the power unit POW to be converted into direct current to be delivered to the battery EVB.

This technical solution is not, however, free of problems.

In this regard, it is good, first of all, to explain that the command unit COM must be placed in the proximity of the power unit POW in order to adjust the power factor correction PFC device.

Switching at high electrical voltages present within the power unit POW may, however, generate electromagnetic interference in the command unit COM, which, propagating through the connections from the resistive divider PR to the upstream inputs of the switches SW1, SW2, SW3 and of the auxiliary switches SW4, SW5, can cause major disturbances on the input alternating current.

In addition, it must also be considered that the resistive divider PR is, by definition, a dissipating component and that, therefore, it can result in considerable energy waste if electric current flows through it when not needed. With this fact in mind, it is certainly easy to appreciate that connecting the resistive divider PR upstream of the switches SW1, SW2, SW3 and of the auxiliary switches SW4, SW5 is a rather inconvenient technical solution.

In fact, in this case, once the input stage S IN is connected to the power supply line, the resistive divider PR is traversed by the alternating current regardless of whether the switches SW1, SW2, SW3 and the auxiliary switches SW4, SW5 are open or closed.

It is clear how this fact results in unnecessary waste of energy within the appliance and, as a direct consequence, a lower overall efficiency of the same. Finally, it is also worth mentioning that the instantaneous voltages measured by the resistive divider PR upstream of the switches SW1, SW2, SW3 and of the auxiliary switches SW4, SW5 differ, in some cases even significantly, from the voltages actually present at input in the command unit COM.

This fact is due, primarily, to the presence of the input filters F_{IN1}, F_{IN2}, F_{IN3} and the resulting phase corrections carried out.

This difference means, therefore, that appropriate corrections must be made to the values measured by the resistive divider PR; this is typically done by programming the command unit COM so as to match the measured values to those actually present at input in the command unit itself.

However, it is readily apparent that this is unlikely to return accurate results, especially if the voltages have distorted waveforms.

### DESCRIPTION OF THE INVENTION

The main aim of the present invention is to devise an appliance for charging batteries of electric vehicles or the like with efficient, precise and accurate operation that can reduce energy dissipation and electromagnetic disturbances compared with the aforementioned prior art.

Another object of the present invention is to devise an appliance for charging batteries of electric vehicles or the like which can overcome the mentioned drawbacks of the prior art within the framework of a simple, rational, easy and effective to use, as well as affordable solution.

The aforementioned objects are achieved by this appliance for charging batteries of electric vehicles or the like.

### BRIEF DESCRIPTION OF THE DRAWINGS

Other characteristics and advantages of the present invention will become more apparent from the description of a preferred, but not exclusive, embodiment of an appliance for charging batteries of electric vehicles or the like, illustrated by way of an indicative, yet non-limiting example, in the accompanying tables of drawings in which:

FIG. 1 schematically shows an appliance of known type;

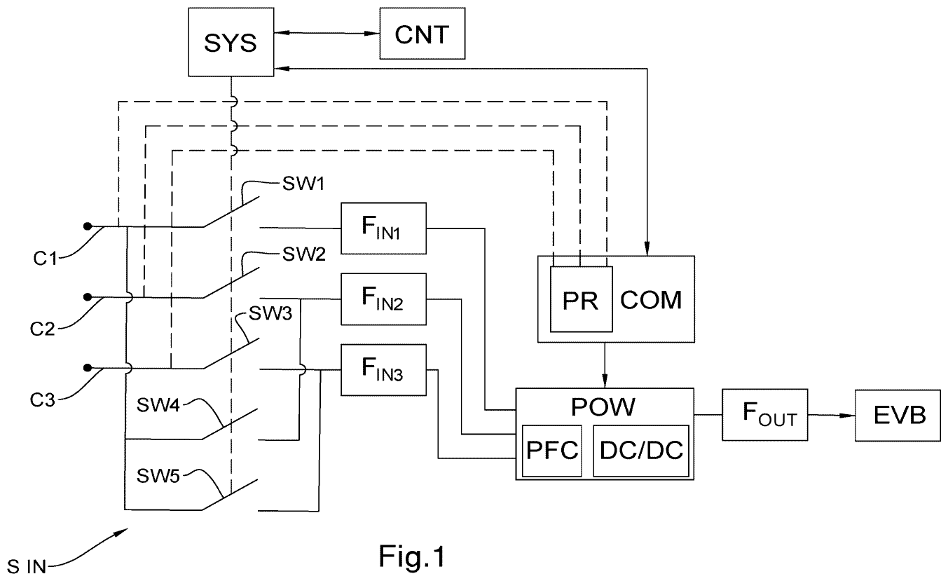

FIG. 2 schematically shows the appliance according to the invention.

### EMBODIMENTS OF THE INVENTION

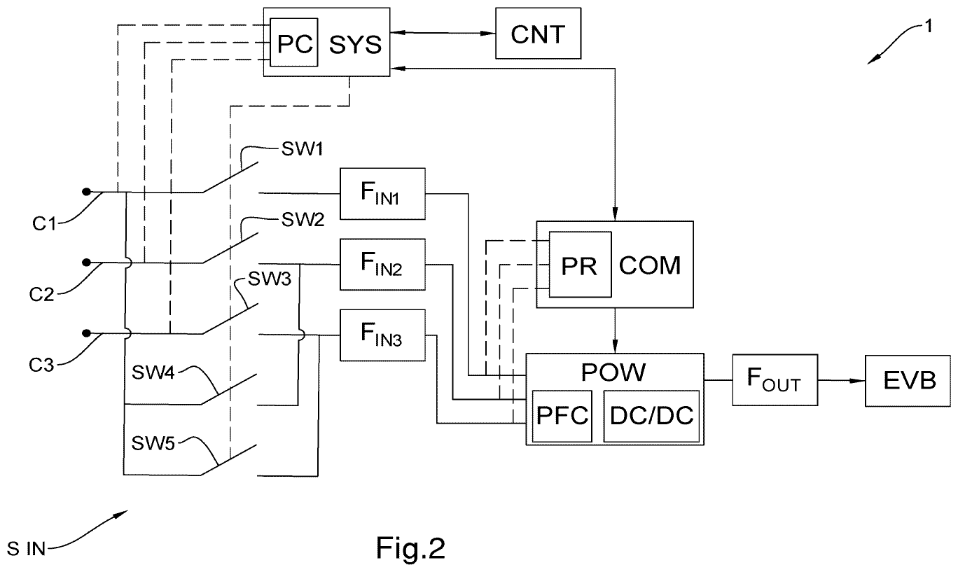

With particular reference to FIG. 2, reference numeral 1 globally denotes an appliance for charging batteries of electric vehicles or the like.

The appliance 1 for charging batteries of electric vehicles or the like comprises at least one input stage S IN comprising at least one input circuit C1, C2, C3 connectable to at least one AC power supply line and at least one switch SW1, SW2, SW3 positioned along the input circuit C1, C2, C3 which is closable/openable to connect/disconnect the at least one input circuit C1, C2, C3 to/from the power supply line.

Preferably, the switch SW1, SW2, SW3 is of the type of a two-way relay. Advantageously, the input stage S IN comprises at least one input filter F_{IN1}, F_{IN2}, F_{IN3} which is arranged along the input circuit C1, C2, C3 downstream of the switch SW1, SW2, SW3.

As will become clearer in the remainder of this disclosure, the input filter F_{IN1}, F_{IN2}, F_{IN3} is adapted to filter the disturbances from downstream of the input filter itself.

The appliance 1 then comprises at least one power unit POW that is arranged downstream of the input stage S IN and is provided with an output connectable to at least one battery EVB of at least one electric vehicle.

Specifically, the power unit POW is adapted to receive at input the alternating current and to deliver at output a predefined direct current to be sent to the battery EVB.

To do this, the power unit POW comprises at least one power factor correction PFC device.

The power unit POW may, in addition, comprise other components still such as, e.g., at least one DC/DC converter (shown illustratively in the figures) and/or one or more rectifiers (not shown in the figures).

It should be pointed out in this regard that high-voltage switching occurring within the power unit POW can generate electromagnetic disturbances that are likely to be propagated upstream.

Precisely in this regard, as anticipated, the presence of the input filters F_{IN1}, F_{IN2}, F_{IN3} enables filtering of disturbances from the power unit POW, ensuring that these are eliminated before reaching the power line.

Then, the appliance comprises at least one command unit COM which is operatively located between the input stage S IN and the power unit POW and comprises at least one measuring device PR connected to the input circuit C1, C2, C3.

In the present case, the measuring device PR is adapted to acquire at least one characteristic parameter of electrical voltage, the command unit COM being configured to adjust the power factor correction PFC device depending on the acquired characteristic parameter.

In this case, the characteristic parameter corresponds to the electric voltage value and its waveform.

In particular, the measuring device PR comprises at least one resistive divider. Specifically, the measuring device PR consists of a resistive divider.

According to the invention, the measuring device PR is connected to the input circuit C1, C2, C3 downstream of the latter.

Precisely, as visible in FIG. 2, the measuring device PR is connected to the input circuit C1, C2, C3 downstream of the input filters F_{IN1}, F_{IN2}, F_{IN3}.

It is important to point out in this regard that the aforementioned connection between the measuring device PR and the input circuit C1, C2, C3 allows achieving a twofold benefit.

Firstly, it ensures that any electromagnetic interference present in the command unit COM and due to the proximity between the latter and the power unit POW is not propagated upstream of the switch SW1, SW2, SW3 avoiding, in compliance with electromagnetic compatibility regulations, injecting disturbances into the network.

Secondly, the aforementioned connection also makes it possible to measure electrical voltage values that actually correspond to those present at input of the power unit POW.

This means that, in this case, no correction of measured values is necessary.

What is more, this fact greatly simplifies the control of the power factor correction PFC device, making its correction somewhat more accurate. Conveniently, the appliance comprises at least one output filter Four which is arranged downstream of the power unit POW.

In addition, the appliance comprises at least one interface unit SYS which is connected to at least one control unit CNT of the electric vehicle.

In this regard, the interface unit SYS is also connected to the command unit COM and is configured to send signals from the command unit COM to the control unit CNT containing information regarding, for example, electrical conversion parameters such as input and output current, operating temperatures, electrical conversion efficiency, and more.

In addition, the interface unit SYS is connected to the switch SW1, SW2, SW3 and is configured to send at least one closing/opening signal to the latter.

According to the invention, the interface unit SYS comprises at least one detection device PC which is operatively connected to the input circuit C1, C2, C3 upstream of the switch SW1, SW2, SW3 and is configured to detect the presence of the electrical voltage and to generate, following the detection, at least one presence/absence signal, the interface unit SYS being configured to switch the presence/absence signal into the closing/opening signal.

This means that, in actual facts, the interface unit SYS closes/keeps the switch SW1, SW2, SW3 closed if the detection device PC detects, upstream of the latter, the presence of electrical voltage.

Otherwise, that is, if the detection device PC detects, upstream of the switch SW1, SW2, SW3, the absence of electrical voltage, then the interface unit SYS opens/maintains the switch itself open.

It is convenient, at this point, to explain that in the preferred embodiment of the appliance 1 shown in FIG. 2, the input stage S IN comprises:
at least a first input circuit C1, at least a second input circuit C2 and at least a third input circuit C3 connected in parallel to the detection device PC; and
at least a first switch SW1, at least a second switch SW2 and at least a third switch SW3 arranged along the first input circuit C1, along the second input circuit C2 and along the third input circuit C3, respectively; and
at least a first input filter F_{IN1}, at least a second input filter F_{IN2} and at least a third input filter F_{IN3} arranged along the first input circuit C1 downstream of the first switch SW1, along the second input circuit C2 downstream of the second switch SW2 and along the third input circuit C3 downstream of the third switch SW3, respectively.

The input stage S IN according to the preferred embodiment substantially comprises three input circuits C1, C2, C3, three switches SW1, SW2, SW3 and three input filters F_{IN1}, F_{IN2}, F_{IN3}.

It cannot, however, be ruled out that the input stage S IN may comprise a different number of input circuits C1, C2, C3, input filters F_{IN1}, F_{IN2}, F_{IN3} and switches SW1, SW2, SW3.

For example, solutions can be envisaged wherein the input stage S IN is provided with two input circuits, each provided with a switch and with an input filter, or other solutions still known to the expert in the field.

It is understood, however, that what is described in the remainder of this disclosure, about only one of the input circuits C1, C2, C3 (e.g., referring to the latter in the singular) is to be considered equally valid for any other input circuits C1, C2, C3.

Similar considerations apply with reference to the switches SW1, SW2, SW3 and to the input filters F_{IN1}, F_{IN2}, F_{IN3}.

As an example and with reference to this preferred embodiment, if the detection device PC detects the presence of electrical voltage upstream of two of the three switches SW1, SW2, SW3, then it generates two presence signals and one absence signal, respectively.

The interface unit SYS switches the two presence signals into two closing signals to be sent to the above two switches SW1, SW2, and switches the absence signal into an opening signal to be sent to the remaining switch SW3. This means that, in general, the interface unit SYS closes/keeps the switches SW1, SW2, SW3 closed upstream of which the detection device PC detects the presence of electrical voltage, and opens/keeps the others open.

Continuing to describe the preferred embodiment shown in FIG. 2, it is convenient to add that the first input circuit C1 comprises at least a first auxiliary switch SW4 which is connected at input upstream of the first switch SW1 and at output downstream of the second switch SW2 and is closable/openable to connect/disconnect the first input circuit C1 to/from the second input circuit C2.

Again, the first input circuit C1 comprises, in addition, at least a second auxiliary switch SW5 which is connected at input upstream of the first switch SW1 and at output downstream of the third switch SW3 and is closable/openable to connect/disconnect the first input circuit C1 to/from the third input circuit C3.

In this regard, the interface unit SYS is configured to send to the first auxiliary switch SW4 and to the second auxiliary switch SW5 at least one closing/opening signal to enable the connection/disconnection of the first input circuit C1 to/from the second input circuit C2 and to/from the third input circuit C3.

Specifically, if the detection device PC detects the presence of electrical voltage upstream of only the first input circuit C1, then it generates a single presence signal which is automatically switched by the interface unit SYS into a closing signal of the first auxiliary switch SW4 and of the second auxiliary switch SW5. This means that, in actual facts, the interface unit SYS closes/keeps the first auxiliary switch SW4 and the second auxiliary switch SW5 closed if the detection device PC detects, upstream of only the first input circuit C1, the presence of electrical voltage.

Thus, in this particular circumstance, the interface unit SYS closes/keeps the first switch SW1, the first auxiliary switch SW4 and the second auxiliary switch SW5 closed.

It is convenient to explain that this technical expedient allows, in the absence of voltage on the second input circuit C2 and on the third input circuit C3, supplying single-phase power to the appliance 1, obtaining higher output powers than would be obtained by exploiting only the first input circuit C1.

Preferably, the first auxiliary switch SW4 and the second auxiliary switch SW5 are of the type of two-way relays.

In other words, the first auxiliary switch SW4 and the second auxiliary switch SW5 are functionally quite similar to the first switch SW1, to the second switch SW2 and to the third switch SW3.

Usefully, the detection device PC comprises at least one capacitive partition. Specifically, the detection device PC consists of a capacitive divider.

It is important to point out in this regard that providing a detection device PC of the type of a capacitive divider connected upstream of the switches SW1, SW2, SW3 for the detection of input voltages makes it possible to command the opening and closing of the switches SW1, SW2, SW3 in an absolutely profitable manner while at the same time avoiding unnecessary energy dissipation.

In fact, unlike the resistive divider, the capacitive divider is, ideally, a non-dissipating component; therefore, it can be used for electric voltage detection upstream of the switches SW1, SW2, SW3 without resulting in expensive waste of energy.

In other words, the energy dissipation introduced by the use of the capacitive divider for electric voltage detection is totally negligible compared to that introduced by employing the resistive divider for this purpose.

It is easy, then, to appreciate how the fact of providing a capacitive divider enables an almost total reduction in the power consumption required to detect the presence/absence of electrical voltage.

It has in practice been ascertained that the described invention achieves the intended objects.

In particular, the fact is emphasized that the special expedient of connecting a capacitive divider upstream of the switches for detecting input voltages makes it possible to command the opening and closing of the same in an absolutely profitable manner and, at the same time, to reduce energy dissipation compared with the prior art mentioned above.

In addition, the fact is emphasized that the special expedient of connecting the resistive divider to the input filters downstream of the latter ensures that any electromagnetic interference in the command unit cannot propagate upstream of the switches and that, therefore, the alternating current at input is not disturbed. Not only that, but it is important to point out that the same expedient also makes it possible to measure values of electrical voltages that actually correspond to those at input of the command unit.

In this way, correction of these values by means of special programming of the command unit is completely unnecessary, and adjustment of the power factor correction device proves to be somewhat simplified.

1. Appliance (1) for charging batteries of electric vehicles or the like, comprising:
at least one input stage (S IN) comprising at least one input circuit (C1, C2, C3) connectable to at least one AC power supply line and at least one switch (SW1, SW2, SW3) positioned along said input circuit (C1, C2, C3) which is closable/openable to connect/disconnect said at least one input circuit (C1, C2, C3) to/from said power supply line;
at least one power unit (POW), arranged downstream of said input stage (S IN), which is provided with an output connectable to at least one battery (EVB) of at least one electric vehicle and comprises at least one power factor correction (PFC) device, said power unit (POW) being adapted to receive at input said alternating current and to deliver at output a predefined direct current to be sent to said battery (EVB);
at least one command unit (COM) which is operatively positioned between said input stage (S IN) and said power unit (POW) and comprises at least one measuring device (PR) connected to said input circuit (C1, C2, C3) and adapted to acquire at least one characteristic parameter of electrical voltage, said command unit (COM) being configured to adjust said power factor correction (PFC) device depending on said acquired characteristic parameter;
at least one interface unit (SYS) which is connected to at least one control unit (CNT) of said electric vehicle, said interface unit (SYS) being operatively connected to said switch (SW1, SW2, SW3) and being configured to send to the latter at least one closing/opening signal;
characterized by the fact that:
said interface unit (SYS) comprises at least one detection device (PC) which is operatively connected to said input circuit (C1, C2, C3), upstream of said switch (SW1, SW2, SW3) and is configured to detect the presence of said electrical voltage and to generate, as a result of said detection, at least one presence/absence signal, said interface unit (SYS) being configured to switch said presence/absence signal into said closing/opening signal;
said measuring device (PR) is connected to said input circuit (C1, C2, C3) downstream of the latter.

2. Appliance (1) according to claim 1, characterized by the fact that said detection device (PC) comprises at least one capacitive divider.

3. Appliance (1) according to claim 1, characterized by the fact that said input stage (S IN) comprises at least one input filter (F_{IN1}, F_{IN2}, F_{IN3}) which is arranged along said input circuit (C1, C2, C3) downstream of said switch (SW1, SW2, SW3).

4. Appliance (1) according to claim 1, characterized by the fact that said input stage (S IN) comprises:
at least a first input circuit (C1), at least a second input circuit (C2) and at least a third input circuit (C3) connected in parallel to said detection device (PC); and
at least a first switch (SW1), at least a second switch (SW2) and at least a third switch (SW3) arranged along said first input circuit (C1), along said second input circuit (C2) and along said third input circuit (C3), respectively;
at least a first input filter (F_{IN1}), at least a second input filter (F_{IN2}) and at least a third input filter (F_{IN3}) arranged along said first input circuit (C1) downstream of said first switch (SW1), along said second input circuit (C2) downstream of said second switch (SW2) and along said third input circuit (C3) downstream of said third switch (SW3), respectively.

5. Appliance (1) according to claim 4, characterized by the fact that said first input circuit (C1) comprises:
at least a first auxiliary switch (SW4) which is connected at input upstream of said first switch (SW1) and at output downstream of said second switch (SW2) and is closable/openable to connect/disconnect said first input circuit (C1) to/from said second input circuit (C2); and
at least a second auxiliary switch (SW5) which is connected at input upstream of said first switch (SW1) and at output downstream of said third switch (SW3) and is closable/openable to connect/disconnect said first input circuit (C1) to/from said third input circuit (C3).

6. Appliance (1) according to claim 1, characterized by the fact that it comprises at least one output filter (F_{OUT}) which is arranged downstream said power unit (POW).

7. Appliance (1) according to claim 1, characterized by the fact that said measuring device (PR) comprises at least one resistive divider.

8. Appliance (1) according to claim 1, characterized by the fact that at least one of said switches (SW1, SW2, SW3), said first auxiliary switch (SW4) and said second auxiliary switch (SW5) are of the type of two-way relays.
